(19) United States
(12) Patent Application Publication
(10) Pub. No.: US 2019/0070702 A1
(43) Pub. Date: Mar. 7, 2019

(54) DUST COLLECTING COVER AND DUST COLLECTING METHOD FOR ELECTRIC CIRCULAR SAW

(71) Applicant: Chengfeng ZHANG, Guangdong (CN)

(72) Inventors: Chengfeng ZHANG, Guangdong (CN); Chengyu ZHANG, Hunan (CN)

(73) Assignee: Chengfeng ZHANG, Guangdong (CN)

(21) Appl. No.: 16/080,660

(22) PCT Filed: Feb. 27, 2017
(86) PCT No.: PCT/CN2017/074946

§ 371 Date: Aug. 28, 2018

(30) Foreign Application Priority Data
Feb. 29, 2016 (CN) 201610109946.0
Feb. 29, 2016 (CN) 201620149259.7

(51) Int. Cl. B23Q 11/00; B23Q 11/08; B23Q 11/06

(52) U.S. Cl. CPC B23Q 11/0046; B23Q 11/06; B23Q 11/08

(57) ABSTRACT

A dust-collecting cover for an electric circular saw includes a dust-collecting cover body configured as a cavity structure thereinside. A bottom surface of a cavity is formed with a strip-shaped opening, which is used for a saw blade to pass therethrough. Other surfaces of the cavity are configured as closed structures. An airflow passage is automatically formed in the cavity during operation. A pathway of the airflow passage starts from a part of the rear end of the strip-shaped opening adjacent to saw teeth, to a front end of the strip-shaped opening in an arc shape along the outer edge of the saw blade, then turns upwards and rearwards, and along an upper wall of the cavity, then turns downwards, and stops at a part of the rear end of the strip-shaped opening away from the saw blade. A dust-collecting method is disclosed.

### BACKGROUND OF THE INVENTION

### 1. Field of the Invention

The present invention relates to the field of electric tools, and in particular, to a dust-collecting cover and a dust-collecting method for an electric circular saw.

### 2. Description of Related Art

As is well known, when an electric circular saw is placed on a lower side of a cut object to perform a cutting operation, rear teeth of a saw blade throw a large amount of dust to an upper-front side of the saw blade. When the electric circular saw is placed on an upper side of the cut object to perform the cutting operation, the rear teeth of the saw blade throw a large amount of dust to a front-rear side of the saw blade. In such two cases, front teeth of the saw blade simultaneously throw a large amount of dust on the lower side of the cut object. In a known dust-free electric circular saw and dust-collecting device for an electric circular saw, there is still no simple and effective mechanism or method in which dust simultaneously shown on the upper side and the lower side of the cut object can be directly collected to one of the upper side and the lower side of the cut object, and is collected by a dust-collecting device on one of the upper side and the lower side.

Some dustproof covers having a similar function to that of the foregoing dust-collecting cover that currently appear on the market. However, such dust-collecting cover can provide only a particular inhibiting effect on dust thrown by the rear teeth of the saw blade, but cannot collect the dust to the dust-collecting device below the cut object. In addition, some dust suction covers having a similar function to that of the foregoing dust-collecting cover further appear on the market. Such dust suction cover is only a secondary dust suction opening having a cover that is extended from the dust-collecting device. The dust suction cover is connected to the dust-collecting device after bypassing the cut object by using a flexible hose. Because the flexible hose blocks a cutting route of the cut object, the dust suction cover having the flexible hose is extremely inconvenient when cutting a relatively large object.

In addition, in a timber processing plant in which a usage rate of electric circular saws is quite high, people usually arrange two dust suction openings, each having a cover, to respectively collect dust generated on the upper side and the lower side of the cut object. Dust on the upper side of the cut object is collected by the dust suction cover hung above the cut object. The dust suction cover needs to keep a particular distance from the cut object, and the distance leads to an unsatisfactory dust-collecting effect. However, for some small electric circular saws having quite strong mobility, it is particularly unpractical to configure such a complex and large dust-collecting device.

For the foregoing various reasons, widespread promotion and popularity of dust-free operations of electric circular saws are extremely limited. In addition, electric circular saws are significantly used in people's productive processes, such generated dust and powder are too much to be counted, which cause serious harm to physical health of operators and extremely great pollution to operation fields and ambient air.

### SUMMARY OF THE INVENTION

The present invention is directed to overcome the foregoing deficiencies of the conventional existing dust-free electric saw, and to provide a dust-collecting cover for an electric circular saw.

To achieve the foregoing objective, a technical solution of the present invention is: a dust-collecting cover for an electric circular saw, including a dust-collecting cover body that is configured as a cavity structure inside. A bottom surface of a cavity of the dust-collecting cover body is formed with a strip-shaped opening, which is used for a saw blade to pass therethrough. Other surfaces of the cavity are configured as closed structures. The dust-collecting cover body forms an airflow passage communicating with an outside part through only the strip-shaped opening. An air inlet and an air outlet of the airflow passage are both formed at a rear end of the strip-shaped opening, wherein, the air inlet is formed at the part of the rear end of the strip-shaped opening adjacent to saw teeth, and the air outlet is formed at the part of the rear end of the strip-shaped opening away from the saw teeth. A pathway of the airflow passage starts from the part of the rear end of the strip-shaped opening adjacent to the saw teeth, to a front end of the strip-shaped opening in an arc shape along the outer edge of the saw blade, then turns upwards and rearwards, flows towards a rear part of the cavity along an upper wall of the cavity, then turns downwards, and stops at the part of the rear end of the strip-shaped opening away from the saw blade.

An arc-shaped guide wall connecting the front end of the strip-shaped opening and the upper wall of the cavity of the dust-collecting cover body is formed inside a front end of the cavity of the dust-collecting cover body. A rear guide wall connecting the upper wall of the cavity of the dust-collecting cover body and the rear end of the strip-shaped opening is formed inside a rear end of the cavity of the dust-collecting cover body.

An arc-shaped partition board is arranged inside the cavity of the dust-collecting cover body. A rear end of the arc-shaped partition board extends to the rear end of the strip-shaped opening, and divides the rear end of the strip-shaped opening into the part adjacent to the saw teeth and the part away from the saw teeth. The air inlet is formed at the part close to the saw teeth. The air outlet is formed at the part away from the saw teeth. A front end of the arc-shaped partition board extends to a front part of the cavity and is spaced apart from the arc-shaped guide wall with a spacing to form an air vent.

Middle parts of two side inner walls of the strip-shaped opening at the bottom surface of the cavity of the dust-collecting cover body respectively protrude inwards to form limiting protruding strips. A distance between the two limiting convex strips is substantially same as a thickness of the saw blade and is slightly greater than the thickness of the saw blade.

A front surface or a lower side of the front surface outside the dust-collecting cover body is inclined forwardly and downwardly to fouls a guide inclined surface.

A rear-lower corner of the dust-collecting cover body is formed with a mounting slot, which is used for a sheet-shaped connecting bar to pass therethrough. A pin shaft is arranged between two walls of the mounting slot. The sheet-shaped connecting bar having a bottom part that is fixedly connected to a saw table or an electric saw housing is further arranged in the mounting slot. The sheet-shaped connecting bar is formed with a longitudinal through slot, which is used for the pin shaft to vertically pass therethrough.

A rotatable strut is arranged at a position near a front of a middle part on a left side or a right side of the dust-collecting cover body. A length of the rotatable strut is greater than a height of the dust-collecting cover body. a rotating shaft center of the rotatable strut is located at the middle part of the dust-collecting cover body close to an upper edge. A surface of the left side or the right side of the dust-collecting cover body is formed with one or two limiting convex points whose thicknesses are approximately equal to that of the rotatable strut.

The present invention further provides a dust-collecting/suction method for an electric circular saw, to mainly resolve a problem that rear teeth of a saw blade throw dust in an upper-front side or an upper-rear side when passing a kerf of a cut object. The method includes providing a dust-collecting cover on an upper side of a cut object, using a fluid feature formed inside the dust-collecting cover when a saw blade operates, taking a saw kerf of the cut object as a passage, collecting dust thrown to the upper-front side or the upper-rear side by rear teeth of the saw blade to a lower side of the cut object. The dust-collecting cover includes a dust-collecting cover body that is configured as a cavity structure inside. A bottom surface of a cavity of the dust-collecting cover body is formed with a strip-shaped opening, which is used for a saw blade to pass therethrough. Other surfaces of the cavity are configured as closed structures. The dust-collecting cover body forms an airflow passage communicating with an outside part through only the strip-shaped opening. An air inlet and an air outlet of the airflow passage are both formed at a rear end of the strip-shaped opening, wherein the air inlet is formed at the part of the rear end of the strip-shaped opening adjacent to saw teeth. The air outlet is formed at the part of the rear end of the strip-shaped opening away from the saw teeth. A pathway of the airflow passage starts from the part of the rear end of the strip-shaped opening adjacent to the saw teeth, to a front end of the strip-shaped opening in an arc shape along the outer edge of the saw blade, then turns upwards and rearwards, flows towards a rear part of the cavity along an upper wall of the cavity, then turns downwards, and stops at the part of the rear end of the strip-shaped opening away from the saw blade. In the method, the dust thrown to the upper-front side by the rear teeth of the saw blade first enters the airflow passage of the cavity of the dust-collecting cover body from a part of the rear teeth of the saw blade, close to the saw teeth, with an airflow generated by rotation of the saw teeth, then is entrained by an airflow in the airflow passage to a part of the rear teeth of the saw blade away from the saw teeth, flows, together with the dust thrown to the upper rear side by the rear teeth of the saw blade, to a lower side of the cut object through the saw kerf of the cut object, and then is exhausted together with dust originally generated on the lower side of the cut object.

In the present invention, according to the operation feature of the circular saw blade and the fluid feature, the dust-collecting cover having extremely simple configuration and structure is used, to collect the dust on the upper side of the cut object to the lower side of the cut object through the saw kerf, thereby greatly simplifying the dust suction mechanism of the dust-free electric circular saw, and greatly increasing the dust-collecting effect of the dust-free electric circular saw. This is of great significance to miniaturization and portability of the dust-free electric circular saw (or a cutting machine) and popularization of dust-free cutting in the cutting industry.

### BRIEF DESCRIPTION OF THE DRAWINGS

FIG. 1 is a planar structural diagram of a body of a dust-collecting cover according to an embodiment of the present invention.

FIG. 2 is a bottom view of a dust-collecting cover body according to the present invention.

FIG. 3 is a schematic internal planar diagram of an opened dust-collecting cover body according to the present invention.

FIG. 4 is a schematic diagram of a dust-collecting cover in use according to the present invention.

FIG. 5 and FIG. 6 are planar structural diagrams of a dust-collecting cover body according to another embodiment of the present invention.

FIG. 7 is a schematic diagram of the dust-collecting cover body in another usage state according to the present invention.

FIG. 8 is a schematic diagram of a body of the dust-collecting cover according to another embodiment of the present invention.

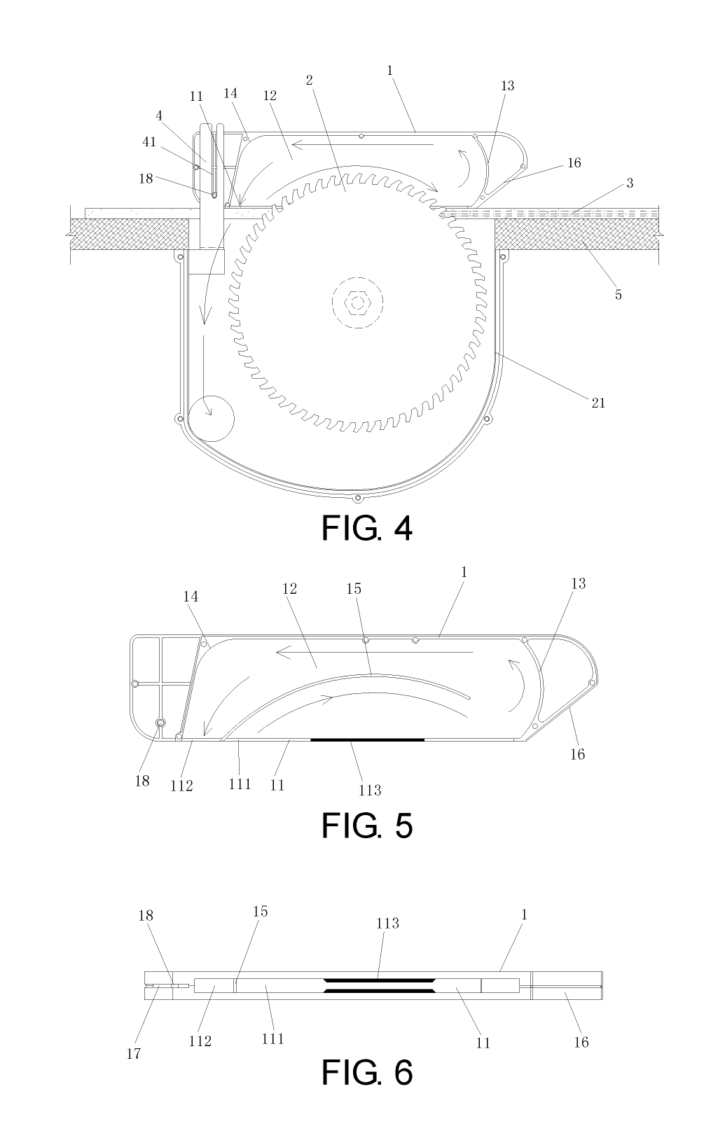

Arrows in FIG. 1, FIG. 4 and FIG. 8 represent airflow directions.

### DESCRIPTION OF THE EMBODIMENTS

The following further describes the present invention with reference to the accompanying drawings and embodiments.

As shown in FIG. 1 to FIG. 3, described by the present invention is a dust-collecting cover for an electric circular saw, including a dust-collecting cover body 1 that is configured as a cavity structure inside. A bottom surface of a cavity of the dust-collecting cover body 1 is formed with a strip-shaped opening 11, which is used for a saw blade to pass therethrough. An airflow passage communicating with an outside part through only the strip-shaped opening 11 is for lied in the cavity 12 of the dust-collecting cover body 1. An air inlet and an air outlet of the airflow passage are both formed at a rear end of the strip-shaped opening 11, wherein the air inlet is formed at a part 111 of the rear end of the strip-shaped opening adjacent to saw teeth, and the air outlet is formed at a part 112 of the rear end of the strip-shaped opening away from the saw teeth. An airflow formed in the airflow passage in the cavity 12 enters the dust-collecting cover body 1 from the part 111 of the rear end of the strip-shaped opening 11 adjacent to the saw teeth, then flows towards a front end of the strip-shaped opening 11 in an arc shape along the outer edge of the saw blade. Then, the airflow turns upwards and rearwards, flows towards a rear part of the cavity 12 along an upper surface inside the cavity 12 of the dust-collecting cover body 1 under a baffling and guiding effect of a surface of a cut object at the front end of the strip-shaped opening 11 and a front wall of the cavity 12 inside the dust-collecting cover body 1. Then, the airflow turns downwards, and flows out of the dust-collecting cover body 1 from the part 112 of the rear end of the strip-shaped opening 11 away from the saw teeth under a baffling and guiding effect of a rear wall of the cavity 12. The air inlet and the air outlet at the rear end of the strip-shaped opening 11 are naturally formed from an internal airflow direction. Because an airflow generated when the saw blade operates at a high speed enters the cavity 12 of the dust-collecting cover body 1 along the part 111 close to the saw teeth, when in condition that other surfaces of the cavity 12 are all closed, the front end of the strip-shaped opening 11 is blocked by the cut object, and a saw kerf exists at the rear end of the strip-shaped opening 11, the airflow necessarily flows out of the part 112 away from the saw teeth.

Further, in the foregoing dust-collecting cover body, an arc-shaped guide wall 13 connecting the front end of the strip-shaped opening 11 and the upper wall of the body 1 of the dust-collecting cover is formed inside a front end of the dust-collecting cover body 1. A rear guide wall 14 connecting the upper wall of the body 1 of the dust-collecting cover and the rear end of the strip-shaped opening is formed inside a rear end of the dust-collecting cover body 1.

Alternatively, as shown in FIG. 5 and FIG. 6, in another embodiment, an arc-shaped partition board 15 is arranged in the cavity 12 inside the dust-collecting cover body 1. A degree of curvature of the arc-shaped partition board 15 is equal to a degree of curvature of an arc of a saw blade 2. A rear end of the arc-shaped partition board 15 extends to the rear end of the strip-shaped opening 11, and divides the rear end of the strip-shaped opening 11 into the part 111 adjacent to the saw teeth and the part 112 away from the saw teeth. The air inlet is formed at the part 111 adjacent to the saw teeth. The air outlet is formed at the part 112 away from the saw teeth. A front end of the arc-shaped partition board 15 extends to a front part of the dust-collecting cover body 1 and is spaced apart from the arc-shaped guide wall 13 with a spacing to form an air vent. When rear teeth of the saw blade throw dust to an upper-front side of the saw blade 2, an equivalent result can also be achieved without an arc-shaped partition board. Adding the arc-shaped partition board 15 can make the airflow passage clearer, and strengthen a structural strength of the dust-collecting cover.

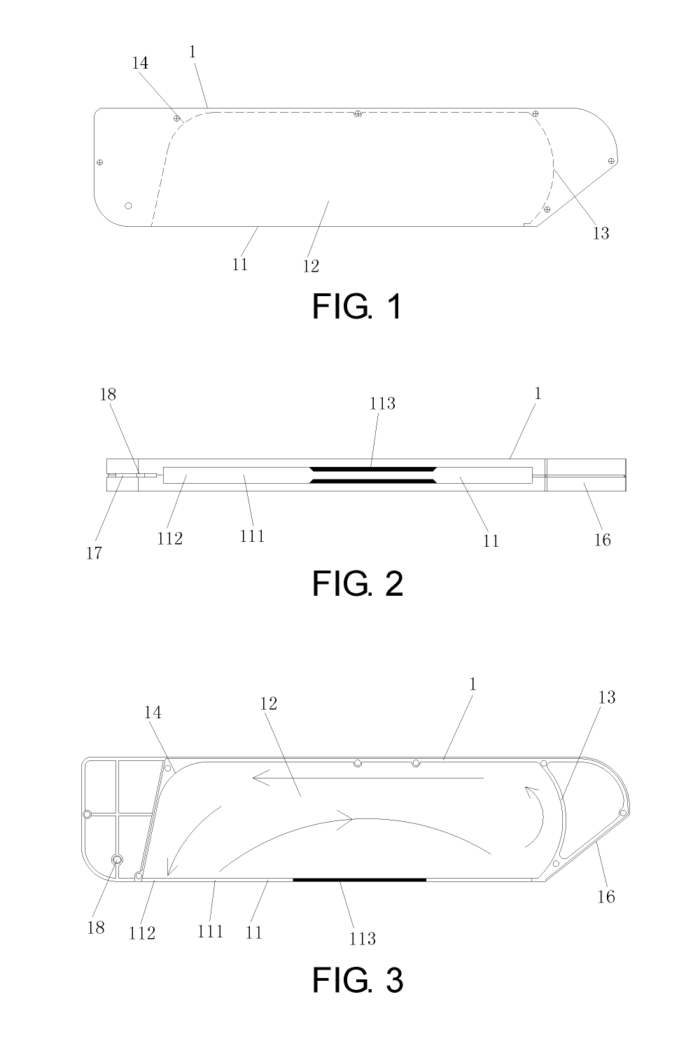

Further, with reference to FIG. 2, middle parts of two side inner walls of the strip-shaped opening 11 at the bottom surface of the dust-collecting cover body 1 respectively protrude inwards to form limiting protruding strips 113. A distance between the two limiting protruding strips 113 is substantially same as a thickness of the saw blade 2, and is slightly greater than the thickness of the saw blade. By using the two limiting protruding strips 113, the dust-collecting cover body 1 does not have a relatively large offset during operation, and does not come into contact with saw teeth part of the saw blade 2 even though having an offset, but only rubs two side surfaces of the saw blade 2. Therefore, the dust-collecting cover can be prevented from being scratched or battered down by the saw blade, so as to ensure security during operation.

An outside of the front surface of the dust-collecting cover body 1 is a guide inclined surface 16 inclining forwards and downwards. That is, an acute angle exists between the guide inclined surface 16 and a surface of a saw table 5. This helps a cut object 3 conveniently enter a lower side of the dust-collecting cover body 1 from the part between the front surface of the dust-collecting cover body 1 and an upper surface of the saw table 5.

In the present embodiment, the dust-collecting cover body 1 is formed by assembling two left and right cover housings symmetrical to each other via a screw. The arc-shaped guide wall 13, the rear guide wall 14, and the like inside the dust-collecting cover body 1 are assembled by rib shaped on inner sides of the two cover housings.

With reference to FIG. 2 and FIG. 4, a rear-lower corner of the dust-collecting cover body is formed with a mounting slot 17, which is used for a sheet-shaped connecting bar to pass therethrough. A pin shaft 18 is arranged between two walls of the mounting slot 17. The dust-collecting cover body 1 is mounted by using a sheet-shaped connecting bar 4. A bottom end of the sheet-shaped connecting bar 4 is fixed on the saw table or an electric saw housing. A longitudinal through slot 41 is arranged on the sheet-shaped connecting bar 4. During mounting, the sheet-shaped connecting bar 4 inserts through the mounting slot 17 of the dust-collecting cover body 1, and the pin shaft 18 in the mounting slot 17 traverses the through slot 41 of the sheet-shaped connecting bar 4, thereby forming horizontally-restrained but vertically-movable mounting. That is, the dust-collecting cover body 1 may move vertically along the longitudinal through slot 41 of the sheet-shaped connecting bar 4, so that the dust-collecting cover body 1 can be lifted by the cut object 3 and be automatically attached to the surface of the cut object without moving back and forth with the cut object. Simultaneously, the sheet-shaped connecting bar 4 is behind the saw blade 2 and the cut object 3 is already sawn after passing the saw blade 2, so that the sheet-shaped connecting bar 4 does not block the cut object 3.

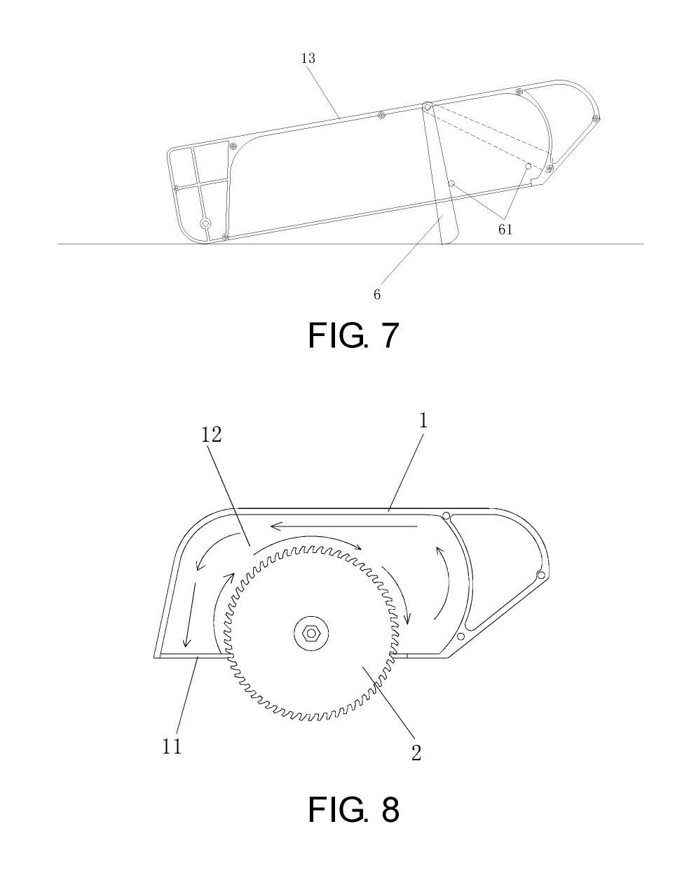

With reference to FIG. 7, in some usage occasions, when an operator needs to perform a saw-cutting operation of relatively high precision, sometimes the dust-collecting cover body 1 needs to be lifted to expose the saw blade, making it convenient for the operator to align a marking line on the cut object with the saw blade. However, frequent lifting and lowering will cause great inconvenience. Therefore, a rotatable strut 6 is arranged at a position near a front of a middle part on a left side or a right side of the dust-collecting cover body 1. A length of the rotatable strut 6 is greater than a height of the dust-collecting cover body 1. A rotating shaft center of the rotatable strut 6 is located at the middle part of the dust-collecting cover body 1 close to an upper edge. A surface of the left side or the right side of the dust-collecting cover body is formed with one or two limiting convex points 61 whose thicknesses are approximately equal to that of the rotatable strut 6. When precise operation needs to be performed, the dust-collecting cover body 1 may be supported by using the rotatable strut 6 in the manner shown in FIG. 7, thereby helping the operator perform an alignment operation. After the alignment, when the cut object is pushed to perform saw-cutting, the cut object pushes a bottom part of the rotatable strut 6 to swing to the left side of the figure. The supporting effect of the rotatable strut 6 on the dust-collecting cover body 1 disappears, and the dust-collecting cover body 1 naturally falls down to be attached to the cut object, thereby implementing a dust-collecting function. After the saw-cutting is completed, when the cut object is pulled back to the right of the figure, because of a friction between a bottom end of the rotatable strut 6 and the surface of the cut object, the rotatable strut 6 is driven to swing to an opposite direction, and support the dust-collecting cover body 1 again, and is positioned when swinging to abut against the limiting convex point 61, to facilitate next operation. The function of the other limiting convex point on the right of the figure is to directly limit the rotatable strut 6 above the limiting convex point without falling down under a state that mostly the rotatable strut 6 does not need to be used. Apparently, the limiting convex point 61 may also be replaced with a bump, a protruding strip, or the like.

The dust-collecting cover in the present invention uses the structural feature of the dust-collecting cover and the operation feature of the circular saw blade and the fluid feature to collect dust on the upper side of the cut object to the lower side of the cut object through the saw kerf, and then the dust enters, together with dust shown on the lower side of the cut object, a dust-collecting device on the lower side of the cut object. The principle lies in that: when the circular saw blade is operated, the rear teeth of the saw blade throw a large amount of dust to the upper-front side or the upper-rear side of the saw blade, front teeth of the saw blade throw a large amount of dust to the rear-lower part of the saw blade; and when the saw blade rotates at a high speed, saw teeth are equivalent to a plurality of small blades to generate airflow. The airflow enters the airflow passage of the cavity from the part 111 of the rear end of the strip-shaped opening of the cavity of the dust-collecting cover adjacent to the saw teeth, and flows towards the front end of the strip-shaped opening 11 with the arc shape of the saw blade. At the front end of the strip-shaped opening 11, because of baffling of the upper surface of the cut object 3 and the front wall of the airflow passage together with the guiding effect of the arc-shaped guide wall 13, the airflow turns upwards and rearwards, and flows towards the rear part of the dust-collecting cover body 1 along the upper surface inside the airflow passage 12 of the dust-collecting cover body 1. Under the guiding effect of the rear guide wall 14 of the rear wall of the airflow passage 12, the airflow turns downwards, and flows out of the dust-collecting cover body 1 through the saw kerf of the sawn cut object from the part 112 of the rear end of the strip-shaped opening 11 away from the saw teeth. The dust generated by the rear teeth of the saw blade is thrown to the airflow passage formed inside the cavity 122 of the dust-collecting cover, is entrained by the airflow in the passage 12 to the part 112 of the rear end of the strip-shaped opening 11 away from the saw teeth, enters a saw blade container 21, then enters, together with the dust generated by the front teeth of the saw blade on the lower side of the cut object 3, the dust-collecting device on the lower side of the cut object. Dust can only move forward due to inertial kinetic energy. However, under the entrainment of the relatively strong airflow in the airflow passage in the cavity, the dust is carried by the airflow to the air outlet in the airflow passage, that is, the part of the rear teeth of the saw blade away from the saw teeth, and finally, the dust flows to the lower side of the cut object through the saw kerf of the cut object.

In the present invention, except for the bottom surface, the other wall surfaces of the cavity of the dust-collecting cover body 1 extends outwards based on the shape of the saw blade after extending into the cavity. Each surface maintains a suitable gap with the saw blade according to a requirement. The front wall of the cavity 12 being arc-shaped is more helpful for the airflow to turn backwards after flowing upwards. The bottom surface on which the strip-shaped opening 11 is in fit attachment with the cut object as much as possible to make enclosed state of the cavity, and the saw kerf of the cut object 3 formed at the rear part of the saw blade is the only outlet of the airflow in the cavity 12.

Further, as shown in FIG. 8, the shape of the dust-collecting cover body in the present embodiment has certain changes, which is applicable to an electric circular saw adapted for operation of the upper side of the cut object, for example, a cutting machine used by a tiler to cut a brick, and so on. Its construction principle is consistent with that in the foregoing embodiment, because during cutting of the saw blades of the two, the airflow is generated at the upper side and the lower side of the cut object, and a large amount of dust is thrown

The present invention further provides a dust-collecting/suction method for an electric circular saw, to mainly resolve a problem that rear teeth of a saw blade throw dust to the upper front side or the upper rear side when passing the kerf of the cut object. The method includes providing the dust-collecting cover on the upper side of a cut object, using the fluid feature formed inside the dust-collecting cover when a saw blade operates, taking the saw kerf of the cut object as a passage, collecting dust thrown to the upper-front side or the upper-rear side by rear teeth of the saw blade to the lower side of the cut object. The dust-collecting cover includes a dust-collecting cover body that is configured as the cavity structure inside. A bottom surface of a cavity of the dust-collecting cover body is formed with a strip-shaped opening, which is used for a saw blade to pass therethrough. The other surfaces of the cavity are configured as closed structures. The dust-collecting cover body forms an airflow passage communicating with the outside part through only the strip-shaped opening. The air inlet and an air outlet of the airflow passage are both formed at the rear end of the strip-shaped opening, wherein the air inlet is formed at the part of the rear end of the strip-shaped opening adjacent to the saw teeth. The air outlet is formed at the part of the rear end of the strip-shaped opening away from the saw teeth. The airflow passage starts from the part of the rear end of the strip-shaped opening adjacent to the saw teeth, to the front end of the strip-shaped opening in an arc shape along the outer edge of the saw blade, then turns upwards and rearwards, flows towards the rear part of the cavity along the upper wall of the cavity, then turns downwards, and stops at the part of the rear end of the strip-shaped opening away from the saw blade. In the method, the dust thrown to the upper-front side by the rear teeth of the saw blade first enters the airflow passage of the cavity of the dust-collecting cover body from the part of the rear teeth of the saw blade adjacent to the saw teeth, with an airflow generated by rotation of the saw teeth, then is entrained by an airflow in the airflow passage to a part of the rear teeth of the saw blade away from the saw teeth, flows, together with the dust thrown to the upper rear side by the rear teeth of the saw blade, to the lower side of the cut object through the saw kerf of the cut object, and then is exhausted together with dust originally generated on the lower side of the cut object. On the lower side of the cut object are usually a saw blade container and a dust suction device communicating with the saw blade container. That is, the dust is sucked by the dust suction device and enters a dust bag.

Based on the above, in the present invention, according to the feature of the circular saw blade and the fluid feature, by means of an extremely simple configuration and structure, the dust on the upper side of the cut object is transferred to the lower side of the cut object through the saw kerf, thereby greatly simplifying the dust suction mechanism of the dust-free electric circular saw, and greatly increasing the dust-collecting effect of the dust-free electric circular saw. This has great significance to miniaturization and portability of the dust-free electric circular saw (or a cutting machine) and popularization of dust-free cutting in the cutting industry.

Apparently, the dust-collecting cover and the dust-collecting method in the present invention is not only applicable to an electric circular saw equipped with a common circular saw blade, a cutting machine, or the like, but also applicable to an electric tool equipped with a grinding wheel cutting blade or a similar circular cutting mediator. For example, a common angle grinder for cutting and grinding is equipped with a grinding wheel cutting blade, and when a cutting operation is performed, rear teeth of a saw blade of the grinding wheel cutting blade all throw dust to the upper-front side or the upper-rear side. Therefore, the present invention is applicable to all electric tools that directly perform cutting operations on operation objects by using circular blade-shaped mediators and that emit the dust from both rear teeth and front teeth of saw blades.

The above application embodiments are only used for describing the present invention, but the present invention is not limited to the above disclosed embodiments, and should cover various modifications and equivalent combinations made according to the essence of the embodiments.

1. A dust-collecting cover for an electric circular saw, comprising a dust-collecting cover body that is configured as a cavity structure thereinside, wherein, a bottom surface of a cavity of the dust-collecting cover body is formed with a strip-shaped opening, which is used for a saw blade to pass therethrough, other surfaces of the cavity are configured as closed structures; the dust-collecting cover body forms an airflow passage communicating with an outside part through only the strip-shaped opening, an air inlet and an air outlet of the airflow passage are both formed at a rear end of the strip-shaped opening, wherein, the air inlet is formed at a part of the rear end of the strip-shaped opening adjacent to saw teeth, the air outlet is formed at a part of the rear end of the strip-shaped opening away from the saw teeth; a pathway of the airflow passage starts from the part of the rear end of the strip-shaped opening adjacent to the saw teeth, to a front end of the strip-shaped opening in an arc shape along the outer edge of the saw blade, then turns upwards and rearwards, flows towards a rear part of the cavity along an upper wall of the cavity, then turns downwards, and stops at the part of the rear end of the strip-shaped opening away from the saw blade.

2. The dust-collecting cover for an electric circular saw according to claim 1, wherein an arc-shaped guide wall connecting the front end of the strip-shaped opening and the upper wall of the cavity of the dust-collecting cover body is formed inside a front end of the cavity of the dust-collecting cover body, and a rear guide wall connecting the upper wall of the cavity of the dust-collecting cover body and the rear end of the strip-shaped opening is formed inside a rear end of the cavity of the dust-collecting cover body.

3. The dust-collecting cover for an electric circular saw according to claim 1, wherein an arc-shaped partition board is arranged inside the cavity of the dust-collecting cover body, a rear end of the arc-shaped partition board extends to the rear end of the strip-shaped opening, and divides the rear end of the strip-shaped opening into the part adjacent to the saw teeth and the part away from the saw teeth, the air inlet is fainted at the part adjacent to the saw teeth, the air outlet is formed at the part away from the saw teeth, and a front end of the arc-shaped partition board extends to a front part of the cavity and is spaced apart from the arc-shaped guide wall with a spacing to form an air vent.

4. The dust-collecting cover for an electric circular saw according to claim 1, wherein middle parts of two side inner walls of the strip-shaped opening at the bottom surface of the cavity of the dust-collecting cover body respectively protrude inwards to form limiting protruding strips, and a distance between the two limiting protruding strips is substantially same as a thickness of the saw blade and is slightly greater than the thickness of the saw blade.

5. The dust-collecting cover for an electric circular saw according to claim 1, wherein a front surface or a lower side of the front surface outside the dust-collecting cover body is inclined forwards and downwards to form a guide inclined surface.

6. The dust-collecting cover for an electric circular saw according to claim 1, wherein a rear-lower corner of the dust-collecting cover body is formed with a mounting slot, which is used for a sheet-shaped connecting bar to pass therethrough, a pin shaft is arranged between two walls of the mounting slot; the sheet-shaped connecting bar having a bottom part that is fixedly connected to a saw table or an electric saw housing is further arranged in the mounting slot, and the sheet-shaped connecting bar is formed with a longitudinal through slot, which is used for the pin shaft to vertically pass therethrough.

7. The dust-collecting cover for an electric circular saw according to claim 1, wherein a rotatable strut is arranged at a position near a front of a middle part on a left side or a right side of the dust-collecting cover body, a length of the rotatable strut is greater than a height of the dust-collecting cover body, a rotating shaft center of the rotatable strut is located at the middle part of the dust-collecting cover body close to an upper edge, and a surface of the left side or the right side of the dust-collecting cover body is formed with one or two limiting convex points whose thicknesses are approximately equal to that of the rotatable strut.

8. A dust-collecting method for an electric circular saw, wherein providing a dust-collecting cover on an upper side of a cut object, using a fluid feature formed inside the dust-collecting cover when a saw blade operates, taking a saw kerf of the cut object as a passage, collecting dust thrown to the upper-front side or an upper-rear side by rear teeth of the saw blade to a lower side of the cut object; the dust-collecting cover including a dust-collecting cover body that is configured as a cavity structure thereinside, a bottom surface of a cavity of the dust-collecting cover body is formed with a strip-shaped opening, which is used for a saw blade to pass therethrough, other surfaces of the cavity are configured as closed structures; the dust-collecting cover body forms an airflow passage communicating with an outside part through only the strip-shaped opening, an air inlet and an air outlet of the airflow passage are both formed at a rear end of the strip-shaped opening, wherein the air inlet is formed at the part of the rear end of the strip-shaped opening adjacent to saw teeth, the air outlet is formed at the part of the rear end of the strip-shaped opening away from the saw teeth; a pathway of the airflow passage starts from the part of the rear end of the strip-shaped opening adjacent to the saw teeth, to a front end of the strip-shaped opening in an arc shape along the outer edge of the saw blade, then turns upwards and rearwards, flows towards a rear part of the cavity along an upper wall of the cavity, then turns downwards and stops at the part of the rear end of the strip-shaped opening away from the saw blade; in the method, the dust thrown to the upper front side by the rear teeth of the saw blade first enters the airflow passage of the cavity of the dust-collecting cover body from a part of the rear teeth of the saw blade, close to the saw teeth, with an airflow generated by rotation of the saw teeth, then is entrained by an airflow in the airflow passage to a part of the rear teeth of the saw blade away from the saw teeth, flows together with the dust thrown to the upper-rear side by the rear teeth of the saw blade to a lower side of the cut object through the saw kerf of the cut object, and then is exhausted together with dust originally generated on the lower side of the cut object.

9. The dust-collecting cover for an electric circular saw according to claim 2, wherein an arc-shaped partition board is arranged inside the cavity of the dust-collecting cover body, a rear end of the arc-shaped partition board extends to the rear end of the strip-shaped opening, and divides the rear end of the strip-shaped opening into the part adjacent to the saw teeth and the part away from the saw teeth, the air inlet is formed at the part adjacent to the saw teeth, the air outlet is formed at the part away from the saw teeth, and a front end of the arc-shaped partition board extends to a front part of the cavity and is spaced apart from the arc-shaped guide wall with a spacing to form an air vent.
